(19) United States
(12) Patent Application Publication
(10) Pub. No.: US 2014/0236840 A1
(43) Pub. Date: Aug. 21, 2014

(54) Payepos Card or Payepos Top Up Card

(71) Applicant: Md. Saidul Islam, Harlow (GB)

(72) Inventor: Md. Saidul Islam, Harlow (GB)

(21) Appl. No.: 14/085,412

(22) Filed: Apr. 25, 2014

(30) Foreign Application Priority Data
Nov. 23, 2012 (GB) 1221103.3

(51) Int. Cl. G06Q 20/20; G06Q 20/38; G06Q 20/40

(52) U.S. Cl. CPC G06Q 20/204; G06Q 20/40; G06Q 20/382
USPC 705/72; 705/17; 705/44; 705/39; 705/16

(57) ABSTRACT

Payepos Card or Payepos Top Up Card is a card to send and receive money is a most robust way to curb payments fraud. This is a magnetic swipe card with 16 or more digit card number, barcode, PIN OR SECURITY CODE etc. User can pay in cash or use their bank debit or credit card at POS to top up their account to pay websites, shopping, businesses and individuals. Similarly they can receive money from other Payepos account users, websites, businesses and individuals straight through POS. Furthermore trusted bank or building societies and companies are able to transfer money to Payepos from their existing arrangements. User is able to transfer balance to their bank account. www.payepos.com and any form of future developments, processes, charges, web shopping cart, tools, devices; software and hardware interfaces are integral content of Payepos Card and or Payepos Top Up Card.

Payepos Card or Payepos Top Up Card is a safer and faster way to make various form of payment and receive payment. This is a simplified method to make and receive payment using retail magnetic swipe card without disclosing bank card details or sensitive financial information. Card users mainly pay cash or pay using debit credit card at POS to top up Payepos Card or Payepos Top Up Card. Payepos stores and safeguards user card and bank details verifying identity and address proof to enable advanced automated services. Users can choose cash only or advanced verified services depending on their requirements. Users can pay online using their Payepos Card or Payepos Top Up Card after adding and successfully updating balance to the card. ID card and address proof verified at stores every time users exceed legal balance limit to ensure security. Payepos does not trigger any tender until enough incoming amount or top up successfully added to current balance. This condition is intact in any circumstances. Cash payments at checkout are highly recommended and retailer ensures utmost vigilant for Chip and Pin card and ID verification. These natures of processes are also more acceptable for web and telephone sellers; in addition fraudulent buyer incurs various footprints during the card top up.

Payepos program generate unique card number at POS/ePOS and www.payepos.com and previously generated unique card numbers are embed to magnetic swipe cards. Customers can register these cards at early or later stages. These card details are saved in Payepos database. These Payepos Cards and Payepos accounts enable customers and businesses to send and receive money between each others. The database records amounts balance data, form of payments, users, identities, bank details, debit or credit card details, addresses, payment locations, transmission and other data at real time basis. Data driven content management website with innovative safeguards and architectures allows customers create accounts assigned to Payepos Cards. Registration is allowed in both earlier and later stages of obtaining a Payepos Cards or generated Payepos Cards on POS/ePOS receipts. These configurations enable users pay cash or pay using debit or credit card to top up Payepos Card or Payepos Top Up Card at POS/ePOS and on www.payepos.com. Payepos program verify incoming payments or available account balance before transmitting outgoing payments.

Users can assign their unique email address, first name, last name, DOB, address, and personal details to this magnetic card. But at the beginning card will work without these details until usages limit exceeds. Various details will be used at ePOS to pay money each other, record and monitoring purpose. Payepos will hold money and customer can transfer balance to their personal bank account any time they like. Cash transaction will reduce both users and retailers dependencies on Visa, Master card and cost along with enhancing security. All online website money market, super market will be paid by this card. Furthermore user reduce their risk of payment failure for legal purchases like road tax, motor insurance etc to avoid loss of cover in case of incident and unexpected prosecution. Users can find Payepos and transaction details from www.payepos.com and participating retail checkout. They also can download transaction details in CSV and various formats. Although this is not a bank or credit card may contain CVV number, chip, sort code account number etc. This is an exceptional tool to point customers about Funfair, Football, Grand Prix and numerous other national, international events and festivals. Entire system need to be in dynamic state to attract customers for all product and services available in retail.

The Payepos system architecture configure retail interfaces at top of system hierarchy wherein websites, businesses, vendors, individuals and Payepos users are at the bottom of the hierarchy. This is an innovative configuration to unify retail and web shoppings in a one transaction. The system processes further configured in reverse direction to ensure two way shopping and money transfers. The system processes further more configured forward and reverse directions according to requirements of websites, businesses, vendors, individuals and Payepos users to ensure inter entities shopping and money transfers.

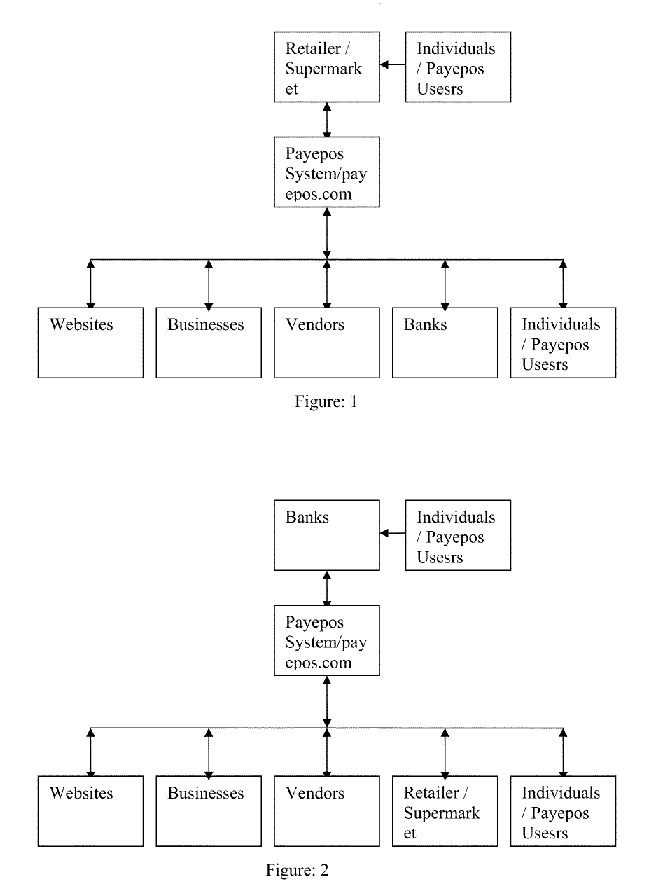

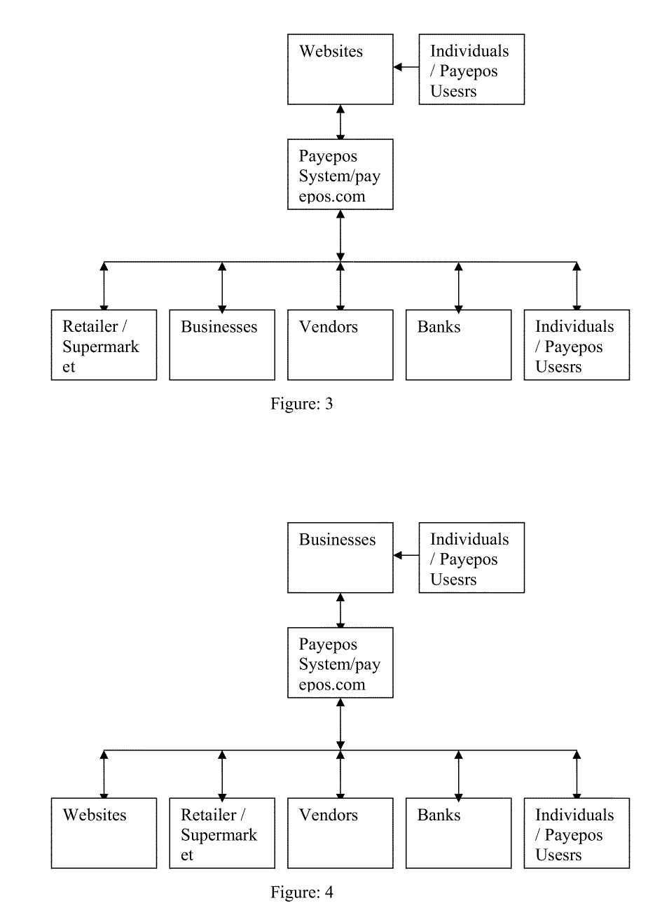

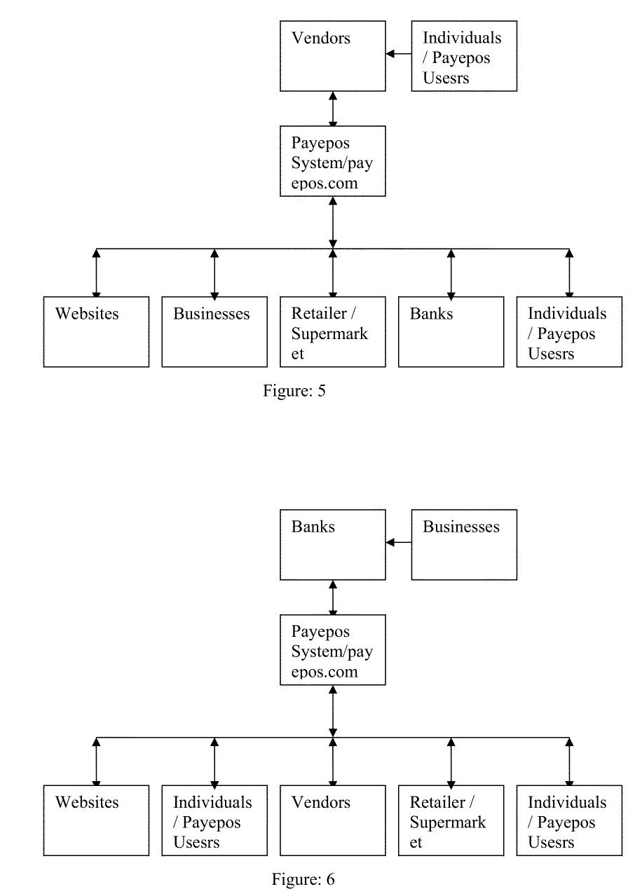

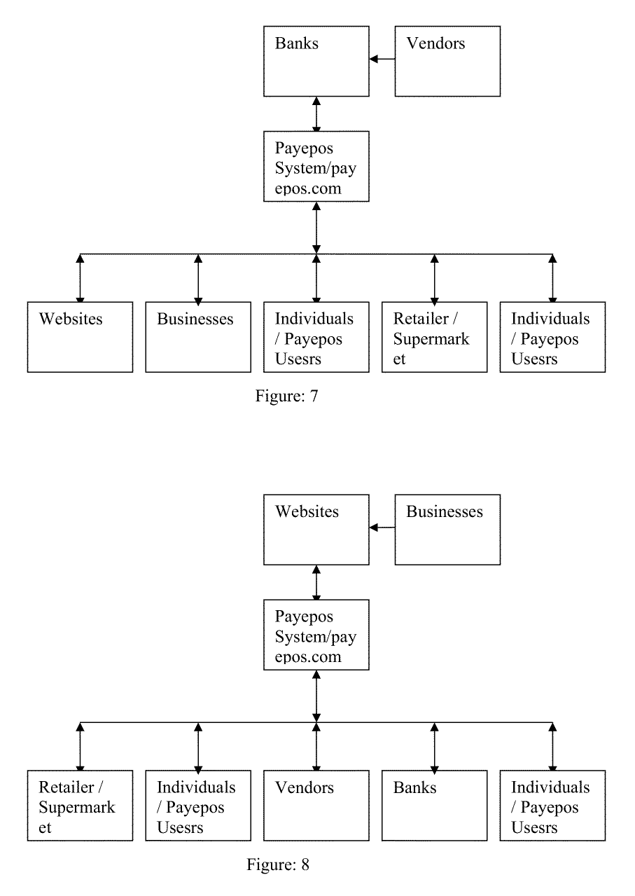

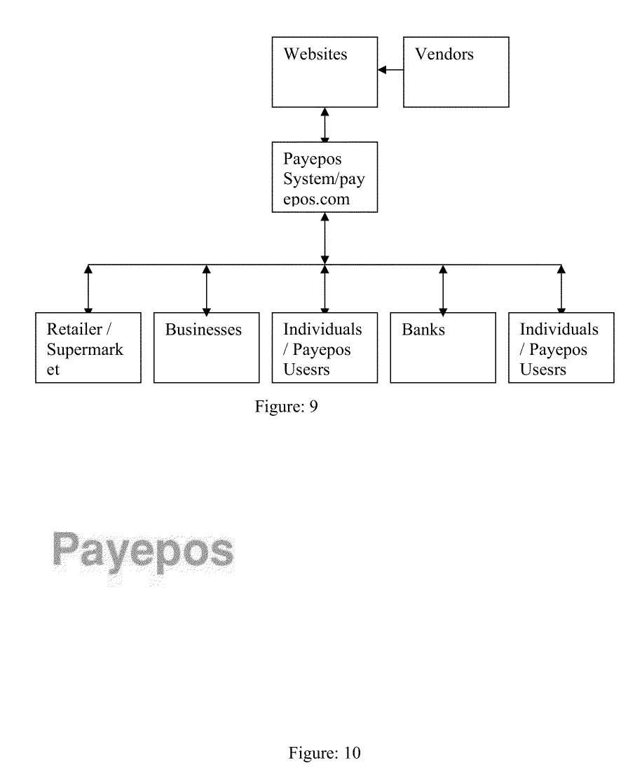

FIG. 1 to FIG. 9 illustrate dynamic processes

### Magnetic Strip Scratch Card

1) Cards will be printed with PIN OR SECURITY CODE, Serial or Card number with 0 balances and multiple customer service numbers

Scratch coated PIN OR SECURITY CODE

Serial or Card numbers are generated with first 6 digits fixed numbers and following 13 digit Serial or Card number.

Transaction charges and Service charges may apply

2) £10 minimum top-up. No value on card until activated at the till.

3) Choose your top-up amount at the till:

Keep me and top-up again

Paypaint mark for third POS payment network facility

Barcode only to scan and operate the card

Calls via 0845 incur a 10 p/min surcharge. Calls from mobile incur a surcharge. For latest call rates to all destinations and all applicable terms, go to www.payepos.com

Option 1

Scan or swipe Payepos Card or Payepos Top Up Card

Pay cash or use bank card to top up.

Option 2

Scan or swipe Payepos Card or Payepos Top Up Card

Scan web shopping barcode

Pay cash or use bank card to complete transaction.

Option 3

Scan or swipe Payepos Card or Payepos Top Up Card

Enter or tell cashier payee Payepos Card or Payepos Top Up Card number

Pay cash or use bank card to send money.

Help

Press @ **# To Top-up @ ***To Save PIN OR SECURITY CODE @ **0 To Clear PIN OR SECURITY CODE

Card may expire 90 days after purchase or last recharge.

You can now top-up at PayPoint terminal or at www.payepos.com

Go to www.payepos.com for details

Service provided by Payepos

678934 00 0000 0050 001

### IVR

IVR is extensively interactive along with IVR payment method to Top Up

After dialing the access numbers

Welcome to Payepos Card or Payepos Top Up Card

Please enter your PIN OR SECURITY CODE number or if you wish to top up or get more information press * now

[Delay] Sorry that PIN OR SECURITY CODE number has not been recognized, please try again . . . . Sorry it has not been possible to process your call please try again later

*

If you like to learn more about our product please press 1 other wise if you like to purchase a card press 2

1

If you want to know how a Payepos Card or Payepos Top Up Card works press 1, for detailed on charges press 2, if you want to know the store press 3, if you want to top up now press 4, you access this selection any time by pressing any key

2

To top up now please press an amount. We accept Visa and Master card but not Maestro card. Card details will be stored securely to make your next payment easier. If this is not acceptable please hang up now other wise please proceed and enter your long 16 digit number on your card followed by the # key.

Sorry you do not have any credit

To top up with debit or credit card please press 1, to top up by e vouchers press 2, to remove your saved details or to enter a new PIN OR SECURITY CODE press 3

### POS E-Top Up

Payepos

Top Up Card

E-Top Up

£300

E-Top Up/PIN OR SECURITY CODE number

657 2449 553

Card number

678934 00 0005 5750 001

**To top-up your existing card**

Step 1: Dial the access number & enter existing card PIN OR SECURITY CODE number

Step 2: Enter **2 (Quick Menu)

Step 3: Enter the 10, 16 or 19 digit e-voucher number printed above

**To use as a Payepos Card or Payepos Top Up Card**

Step 1: Scan shopping bar code

Step 2: Enter the 19 digit e-voucher number printed above

Step 3: Enter the PIN OR SECURITY CODE number printed above

Step 4: Confirm to complete payment

This may expire 90 days from first use or last recharge. Customer Services: 0845. For details, current rates & Terms and conditions visit www.payepos.com.

### POS Receipt

Payepos 300

Please keep safe and take the Customer Service Desk in case of Refund

Product Description: PEP £300

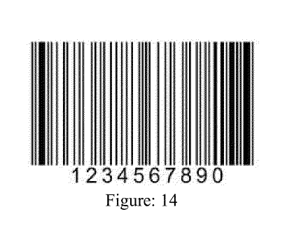

FIG. 14

### POS Refund

Some customers try to miss use refund method. If customers have transferred top up amount, or used any amount refund will be blocked. Refund option need to be very simple after scanning the bar code cashier should be able to refund. In terms of payment network if generic barcode way forward cashier must be able to pass either PIN OR SECURITY CODE or Serial or Card number to erase the amount from the system.

### Simple Customer Service Web Panel

Cashier or customer service advisor are able to find all transaction details using card number, PIN OR SECURITY CODE. They also can verify other data like DOB, email, first name, last name etc. Customers are responsible to save their PIN OR SECURITY CODE. Card number and PIN OR SECURITY CODEs against a transaction details should not be searched. But in case of any customer request customer service should be able to find all PIN OR SECURITY CODES.

### Online Account

Full transactions report, PIN or security code add remove, Account details, Saving Debit/Credit Card for online and IVR payments. Customer also can download history of transaction details.

### Free IVR Highlights

After calling access number *3 for current marketing affairs like following

FIG. 10

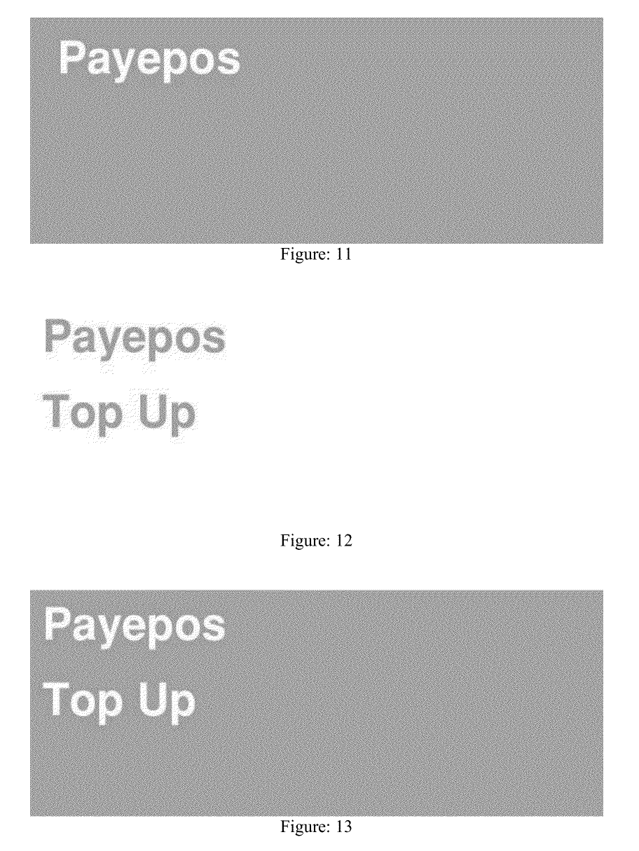

FIG. 11

FIG. 12

FIG. 13

Tips graphics signature will attract customers to find about recent offers.

### IVR Music

After calling access number press *4 for top ten UK music chart, press *5 for sales and promotion offers, *6 for hot retail sale, *7 for hot online sale etc.

### Seasonal Promotion

Discount shopping or reduced rates during Football, Grand Prix and numerous other international events and festivals

We need to offer Discount shopping or reduced rates during Euro 2012.

Immediately after the game, we will not charge to receive a payment using cash payment for one hour. The free period begins at the full time whistle and lasts 60 minutes. Any payment that commences before the free period will be charged in its entirety at the standard rates. Any payment that occurs beyond the free period will be free until the end of the free period, then charged at the standard rates thereafter. Any payment by bank card will be charged at the standard rate and will incur the standard fee. Payment can only be made on Payepos Card or Payepos Top Up Card which have a credit greater than £0.01.

### Text Blast

E-Coupon will be sent to customers through text messages.

### Email Blast

E-Coupon will be sent to customers through email messages.

### E-Coupon

POS E-coupon

£1/50 P/10% off

when you buy

£500 e-top up

offer excludes below or

above £500 e-top up

Valid for use between

Jun. 4, 2012-Jun. 17, 2012

FIG. 14

Hand this coupon to the Checkout Cashier to receive the benefit. Coupon is only valid in UK/IOM and one coupon per transaction. This coupon has no cash value and can be redeemed only once. Excludes Web.

### E-Coupon In Other Form

Payepos sample E-coupon In Other Form comprises:

Payepos Card or Payepos Top Up Card may issue its own eCoupons directly (e.g. via text message or email), via stores or publications or via third parties.

An eCoupon is a unique electronic coupon that provided the benefits or savings detailed against a code. eCoupons can be redeemed on the checkout page when topPIN or security codeg-up/buying a new card on www.payepos.com. eCoupons cannot be used in store or via telephone top-up.

An eCoupon can only be used either as part payment for the item(s) stated on the eCoupon or in conjunction with the minimum spend threshold stated on the coupon in a single transaction.

If we reasonably believe that there is a breach of security or fraudulent use of eCoupons, we may reject any eCoupon.

Once you have used an eCoupon once, you cannot use it again unless otherwise stated. eCoupons may require a valid associated loyalty card number or email address to be given. Unless we tell you otherwise on the eCoupon, eCoupons cannot be used in conjunction with other offers. Payepos Card or Payepos Top Up Card may cancel and reissue any eCoupons and suspend or change any aspects of the operation of eCoupons at our reasonable discretion.

Individual eCoupons may have additional Terms and Conditions which will be published alongside the eCoupon or added to www.payepos.com.

### Generating E-Coupon

E-Coupon is generated analyzing user usages volume, in random basis, Simulation using email, DOB, Name etc. Data from current database is transferred to data file for computer simulation and research. C/c++ Mathematics is used to analyze data in great detail to monitor user behavior and trend.

### Website

Payepos users will not have to disclose their card or bank details to any website or any form of telephone sales. They can fund Payepos Card or Payepos Top Up Card by cash or Debit/Credit cards at POS checkout. After funding the card users can pay online using their Payepos Card or Payepos Top Up Card details or complete the payment at POS checkout disclosing previously obtained a shopping cart reference number or barcode at the website. This shopping cart reference number or barcode will be generated by Payepos integration mechanism with the website. User can integrate their bank, debit credit card detail at www.payepos.com for advanced and faster services.

### Sharing

Epos will produce more than one up to 20 card for a family and unlimited card for business. This sharing is activated among multiple instance of one unique card or multiple unique cards sharing one account or further effective way defining additional Serial or Card number for every individual to track bearer while using same account.

### Simple Sale

User can enter description data of an item in a touch screen monitor in any store. The user can define a fixed price or launch a simple auction to sell. Details will be uploaded to online. Buyer can buy item and pay using Payepos Card or Payepos Top Up Card. If a user unable or experience difficulties to upload an item anyone or customer assistant can help to upload an item.

### Bank Masking

Global population is growing fast and vast number of population migrating towards cities. Electronically supplied services are core of modern life style in these cities. Digital security blocks current virus attack, but cannot stop ever growing cyber threat. Payepos Card or Payepos Top Up Card method is not a bank account and not linked to bank account but bank masking User can create and dispose cards numerous times. But for a security reason all accounts will be reconciled against name, date of birth and address. These details will reconcile all nature of single, joint or shared account.

### Easy Steps

Web, mobile, monitor and touch screen interfaces are advancing in a competitive pace. Developments of features causing amateur users are left behind to coup. Even more technical users dislike new features due to lack of initial environment. In many cases new features are time consuming and not compatible with basic workflow. Main focuses of process are to present every touch screen, online interfaces and POS menu as simple as children game interfaces.

User select or click Payepos at online checkout or payment stage of a web shopping cart. Payepos allows two option pay at store or pay now on the web. If user selects pay at store, payepos generates a barcode for the shopping. Now user takes both of his Payepos Card or Payepos Top Up Card and shopping barcode to a store or shop cashier to pay for the online cart. Cashier swipe the Payepos Card or Payepos Top Up Card and select payweb among menu of Top Up, Payweb, Paytelesale, Paybill, Paysomeone etc, scan or enter shopping barcode, receive payment and complete the transactions. This process is executed in multiple possible flexible ways at POS or self service POS. If user or cashier scans the shopping barcode first POS displays message to swipe or scan the Payepos Card or Payepos Top Up Card to continue. User also can enter Payepos Card or Payepos Top Up Card details when select the pay at store option selecting an additional checkbox option. Balance is transferred from Payepos user account to web seller Payepos account.

User takes Payepos Card or Payepos Top Up Card to a store or shop. User or cashier swipe Payepos Card or Payepos Top Up Card and select Top Up among menu of Top Up, Payweb, Paytelesale, Paybill, Paysomeone etc, pay cash or use bank card to top up the card. User select or click Payepos at online checkout or payment stage of a web shopping cart. Payepos allows two option pay at store or pay now on the web. User selects pay now, Payepos allows to enter card number, security number and additional random check among those user set in advance like DOB, email etc. This process immediately completes the transaction at the website. Balance is transferred from Payepos user account to web seller Payepos account.

User takes Payepos Card or Payepos Top Up Card to a store or shop. User or cashier swipe Payepos Card or Payepos Top Up Card and select Top Up among menu of Top Up, Payweb, Paytelesale, Paybill, Paysomeone etc, pay cash or use bank card to top up the card. If user has enough balance in their Payepos Card or Payepos Top Up Card, either user or cashier can select Paysomeone and enter payee Payepos Card or Payepos Top Up Card number. Similarly user can send money to family member or friends. This process immediately completes the transaction at the store or shop. Balance is transferred from Payepos user account to web seller Payepos account. This entire process is also available at www.payepos.com, user can use online portal if comfortable to do so. User can disclose Payepos Card or Payepos Top Up Card number to other Payepos user and business to receive payments in similar way.

### Shopping List

Users can create, delete shopping list in their www.payepos.com account. They share their shopping list with their assigned or authorized friend or family to shop listed items for them. Touch screen monitor or computer in store allows users to change, amend, print the list and pass message through email and text. These way users can generate shopping records using their Payepos Card or Payepos Top Up Card.

### Drop Shopping

Users can shop and drop shopping in any store using Payepos Card or Payepos Top Up Card, www.payepos.com, Payepos mobile app. They share their shopping list with their assigned or authorized friend or family to shop listed items for them. Users can complete shopping, leave shopping in a safe area in the store. Touch screen monitor or computer in store allows users to email and text their authorized person. The authorized person can collect the shopping later. These way users can generate shopping records using their Payepos Card or Payepos Top Up Card.

### Social Networking

Subscriber can watch friends and family using Payepos Card or Payepos Top Up Card, www.payepos.com, Payepos mobile app in their day to day life without disclosing financial details. They can message each other. Messages can be private or public like a social networking as well as all features of discussion board or others.

### Rating

Local corner shop, off license, retailer can rate website for online shopping and offer option to pay using their POS, touch screen, self service POS etc. They can display website logos and address. Store and website link need to go through Payepos. Payepos and retailer can rate trustworthy websites, telesales; increase coverage and regulate terms and conditions.

Retailer or shop also can arrange simple computer and printer to enable customer for online shopping and printing the shopping barcode. User can buy and sell online item also pay for vital documents like road tax, car insurance etc.

### Cash Back/Cash Withdrawal

User can withdraw cash within coverage of Payment network and banking service in operating country and overseas. User can take balance to permitted country and withdraw balance there. Payepos imposes withdrawal limit and apply terms and condition regarding cash back or cash withdrawal.

### CONCLUSION

Scam website, intrusion of bank card, anonymous unlawful payment, hacking of sensitive financial details is impossible to stop. It is necessary to detach these threats from normal day to day life of transactions. Payepos Card or Payepos Top Up Card is a radical mechanism to curb electronic payment fear and grow successful business relation between buyer and seller. Features in the final product will be more innovative than any other payment network and gateway. All form of present or future software and web developments, innovations, features; hardware devices and tools are content of the main concept.

1. Payepos Card enables user to pay multiple websites, businesses, vendors, banks, and individuals across the world using retail POS/ePOS (Point of Sale), retail self service, bank ATM (cash machine), bank POS/ePOS, www.payepos.com and other existing and forthcoming interfaces. Similarly user can receive money from websites, businesses, vendors, banks, individuals and other Payepos accounts across the world. This is a method for processing transactions to either directions between users and websites (businesses, vendors, banks and individuals) through POS, comprising:
(a) scanning or reading Payepos Card or obtaining account details through POS (Point of Sale) or ePOS or other existing interfaces.
(b) storing earlier shopping cart in the Payepos Card, www.payepos.com, Payepos App to execute transactions.
(c) Paying money using debit or credit card or by cash to Top Up a Payepos Card for a later online payments through www.payepos.com or through an integrated Payepos controls within websites, businesses, vendors, banks and individuals.
(d) Searching by graphical user interface of POS/ePOS screens containing list of items from websites, businesses, vendors, banks, individuals and other Payepos accounts across the world through Payepos platform.
(e) providing users instructions an electronic request and payment executed using step (d) for a fast services like pizza delivery, taxi, train tickets, airline ticket etc.
(g) obtaining telephone or online shopping cart, step (b) and paying by cash or credit or debit card. This process allows customers to buy vital services like Insurance, road tax, mortgage premium etc.
(f) easing various form of shopping difficulties in a simple shopper friendly technique by unifying retail, websites, businesses, vendors, banks and individuals. Customers can complete shopping from retails and websites (businesses, vendors, banks and individuals); earn loyalty rewards using a single Payepos transaction at a POS/Epos. Customers later receive parcel without any more interaction. This unified service is provided using one or multiple processes between (a) and (g), using logics ‘and’, ‘or’, ‘else’ ‘if else’, using various part of claim 1

2. This is a simplified method to make payment and receive payment using retail magnetic swipe card without disclosing bank card details or sensitive financial information. Card users mainly pay cash or pay using debit or credit card at POS to top up Payepos Card or Payepos Top Up Card.

3. Users can integrate their bank card details or sensitive financial information for an advanced automated processing. Payepos stores and safeguards user card and bank details verifying identity and address proof to enable advanced automated services.

4. Users can choose cash only or advanced verified services depending on their requirements.

5. Users can pay online using their Payepos Card or Payepos Top Up Card after adding and successfully updating balance to the card.

6. ID card and address proof verified at stores every time users exceed legal balance limit to ensure security.

7. Payepos does not trigger any tender until enough incoming amount or top up successfully added to current balance.

8. Payepos system enable web sellers, telephone sellers, individual sellers to fix a single or multiple venue of POS/ePOS whereat customers can make the payments. These natures of processes are also more acceptable for sellers. Fraudulent buyers incur various footprints during the card top up and subsequent payment transfer.

9. The Payepos process configure interactive link between retail POS and websites. Payment at the POS is completed to transmit money to a website and target shopping cart, wherein the shopping cart stores an instance of shopping data.

10. Capture and store shopping carts in Payepos Card or Payepos Top Up Card for prolong times. Users also can add, remove and delete these carts at POS/ePOS, www.payepos.com, Payepos Apps, and other interfaces.

11. POS/ePOS interactive graphical user interfaces and Web interfaces locate websites, businesses across the world and list of items to serve.

12. Customers register their Payepos cards, personal and address details at www.payepos.com. POS/ePOS notify and receive customer details for a unregistered Payepos Card to assign customer details and address to the card.

13. Payepos card integrate payment terminals, web technologies, cash payment, debit or credit card payment without customer interactions with the payment terminals and the web technologies. Customers do not require visiting website, select items, adding to shopping cart, finalizing purchase, entering payment details, using computer interface. POS/ePOS terminal configured to receive websites and item detail lists, accept payment and transmit the required fund and customer address to the website.

14. Payepos system enable Online retailers, Websites to transmit coupons, offers, gift amounts to Payepos users

15. Customers describe POS/ePos cashier sender Payepos Card and payee Payepos Card details to send money to a payee instantly by cash or credit or debit card.

16. Payepos GUI at POS/ePOS generates either of sender Payepos Card and payee Payepos Card or both of the cards, if or one or both of the cards are unavailable.

17. Payepos Card enable customers various bills like utilities, Tax, Road Tax etc. The POS/ePOS or www.payepos.com accepts various forms of bill identifications like unique reference number, barcode, alphanumeric reference and all existing forms.

18. Users can assign their unique email address, first name, last name, DOB, address, and personal details to this magnetic card. But at the beginning card will work without these details until usages limit exceeds. Various details will be used at ePOS to pay money each other, record and monitoring purpose.

19. Payepos will hold money and customer can transfer balance to their personal bank account any time they like.

20. Cash transaction will reduce both users and retailers dependencies on Visa, Master card and cost along with enhancing security.

21. All online website money market, super market will be paid by this card.

22. Furthermore user reduce their risk of payment failure for legal purchases like road tax, motor insurance etc to avoid loss of cover in case of incident and unexpected prosecution.

23. Users can find Payepos and transaction details from www.payepos.com and participating retail checkout. They also can download transaction details in CSV and various formats. Although this is not a bank or credit card may contain CVV number, chip, sort code account number etc.

24. Payepos is an exceptional tool to notify customers about Funfair, Football, Grand Prix and numerous other national, international events and festivals. Entire system need to be in dynamic state to attract customers for all product and services available in retail. The notification can be printed on till receipts, published on www.payepos.com, notify within user accounts.

25. Banks, building societies, Credit card companies integrate Payepos for automated money transmission from their accounts for customers

26. Payepos enable retailers to develop smarter promotions like Buy one retail item get one online item free, Buy one retail item get discount on online item etc

27. Payepos system facilitates transmitting money, transmitting various data, emails between all Individuals, Payepos Users, Retailers, Supermarkets, Websites, Businesses, Vendors, Banks, Individuals, Payepos users

28. Payepos Interactive operating system develops many wider solutions to simplify world wide service platforms.

29. Bank and building societies, Credit card companies transfer balance or credit to Payepos Card. They also can integrate the Card for automated services.

30. Features of Payepos Magnetic Stripe Scratch Card comprise:
1) Cards will be printed with PIN OR SECURITY CODE, Serial or Card number with 0 balances and multiple customer service numbers
Scratch coated PIN OR SECURITY CODE
Serial or Card numbers are generated with first 6 digits fixed numbers and following 13 digit Serial or Card number.
Transaction charges and Service charges may apply
2) £10 minimum top-up. No value on card until activated at the till.
3) Choose your top-up amount at the till:
Keep me and top-up again
Paypaint mark for third POS payment network facility
Barcode only to scan and operate the card
Calls via 0845 incur a 10 p/min surcharge. Calls from mobile incur a surcharge. For latest call rates to all destinations and all applicable terms, go to www.payepos.com
Option 1
Scan or swipe Payepos Card or Payepos Top Up Card
Pay cash or use bank card to top up.
Option 2
Scan or swipe Payepos Card or Payepos Top Up Card
Scan web shopping barcode
Pay cash or use bank card to complete transaction.
Option 3
Scan or swipe Payepos Card or Payepos Top Up Card
Enter or tell cashier payee Payepos Card or Payepos Top Up Card number
Pay cash or use bank card to send money.
Help
Press @ **# To Top-up @ ***To Save PIN OR SECURITY CODE @ **0 To Clear PIN OR SECURITY CODE
Card may expire 90 days after purchase or last recharge.
You can now top-up at PayPoint terminal or at www.payepos.com
Go to www.payepos.com for details
Service provided by Payepos 678934 00 0000 0050 001

31. Payepos IVR features comprise:
IVR is extensively interactive along with IVR payment method to Top Up
After dialing the access numbers
Welcome to Payepos Card or Payepos Top Up Card
Please enter your PIN OR SECURITY CODE number or if you wish to top up or get more information press * now
[Delay] Sorry that PIN OR SECURITY CODE number has not been recognized, please try again . . . . Sorry it has not been possible to process your call please try again later
*
If you like to learn more about our product please press 1 other wise if you like to purchase a card press 2
1
If you want to know how a Payepos Card or Payepos Top Up Card works press 1, for detailed on charges press 2, if you want to know the store press 3, if you want to top up now press 4, you access this selection any time by pressing any key
2
To top up now please press an amount. We accept Visa and Master card but not Maestro card. Card details will be stored securely to make your next payment easier. If this is not acceptable please hang up now other wise please proceed and enter your long 16 digit number on your card followed by the # key.
Sorry you do not have any credit
To top up with debit or credit card please press 1, to top up by e vouchers press 2, to remove your saved details or to enter a new PIN OR SECURITY CODE press 3

32. Payepos Top Up card sample POS E-TOP UP format comprises:
Payepos
Top Up Card
E-Top Up
£300
E-Top Up/PIN OR SECURITY CODE number
657 2449 553
Card number
678934 00 0005 5750 001
**To top-up your existing card**
Step 1: Dial the access number & enter existing card PIN OR SECURITY CODE number
Step 2: Enter **2 (Quick Menu)
Step 3: Enter the 10, 16 or 19 digit e-voucher number printed above
**To use as a Payepos Card or Payepos Top Up Card**
Step 1: Scan shopping bar code
Step 2: Enter the 19 digit e-voucher number printed above
Step 3: Enter the PIN OR SECURITY CODE number printed above
Step 4: Confirm to complete payment
This may expire 90 days from first use or last recharge. Customer Services: 0845. For details, current rates & Terms and conditions visit www.payepos.com.

33. Payepos Top Up card sample POS Receipt format comprises:
Payepos 300
Please keep safe and take the Customer Service Desk in case of Refund
Product Description: PEP £300

34. Payepos Top Up card sample POS Refund process comprises:
Some customers try to miss use refund method. If customers have transferred top up amount, or used any amount refund will be blocked. Refund option need to be very simple after scanning the bar code cashier should be able to refund. In terms of payment network if generic barcode way forward cashier must be able to pass either PIN OR SECURITY CODE or Serial or Card number to erase the amount from the system.

35. Payepos sample Simple Customer Service Web Panel comprises:
Cashier or customer service advisor are able to find all transaction details using card number, PIN OR SECURITY CODE. They also can verify other data like DOB, email, first name, last name etc. Customers are responsible to save their PIN OR SECURITY CODE. Card number and PIN OR SECURITY CODEs against a transaction details should not be searched. But in case of any customer request customer service should be able to find all PIN OR SECURITY CODES.

36. Payepos sample Online Account comprises:
Full transactions report, PIN or security code add remove, Account details, Saving Debit/Credit Card for online and IVR payments. Customer also can download history of transaction details.

37. Payepos sample Free IVR Highlights comprises:
After calling access number *3 for current marketing affairs like following

38. Payepos sample IVR Music comprises:
After calling access number press *4 for top ten UK music chart, press *5 for sales and promotion offers, *6 for hot retail sale, *7 for hot online sale etc.

39. Payepos sample Seasonal Promotion comprises:
Discount shopping or reduced rates during Football, Grand Prix and numerous other international events and festivals
We need to offer Discount shopping or reduced rates during Euro 2012.
Immediately after the game, we will not charge to receive a payment using cash payment for one hour. The free period begins at the full time whistle and lasts 60 minutes. Any payment that commences before the free period will be charged in its entirety at the standard rates. Any payment that occurs beyond the free period will be free until the end of the free period, then charged at the standard rates thereafter. Any payment by bank card will be charged at the standard rate and will incur the standard fee. Payment can only be made on Payepos Card or Payepos Top Up Card which have a credit greater than £0.01.

40. Payepos sample E-Coupon comprises:
POS E-coupon
£1/50 P/10% off
when you buy
£500 e-top up
offer excludes below or
above £500 e-top up
Valid for use between
Jun. 6, 2012-Jun. 17, 2012
Hand this coupon to the Checkout Cashier to receive the benefit. Coupon is only valid in UK/IOM and one coupon per transaction. This coupon has no cash value and can be redeemed only once. Excludes Web.

41. Payepos sample E-coupon In Other Form comprises:
Payepos Card or Payepos Top Up Card may issue its own eCoupons directly (e.g. via text message or email), via stores or publications or via third parties.
An eCoupon is a unique electronic coupon that provided the benefits or savings detailed against a code. eCoupons can be redeemed on the checkout page when topPIN or security codeg-up/buying a new card on www.payepos.com. eCoupons cannot be used in store or via telephone top-up.
An eCoupon can only be used either as part payment for the item(s) stated on the eCoupon or in conjunction with the minimum spend threshold stated on the coupon in a single transaction.
If we reasonably believe that there is a breach of security or fraudulent use of eCoupons, we may reject any eCoupon.
Once you have used an eCoupon once, you cannot use it again unless otherwise stated. eCoupons may require a valid associated loyalty card number or email address to be given. Unless we tell you otherwise on the eCoupon, eCoupons cannot be used in conjunction with other offers. Payepos Card or Payepos Top Up Card may cancel and reissue any eCoupons and suspend or change any aspects of the operation of eCoupons at our reasonable discretion.
Individual eCoupons may have additional Terms and Conditions which will be published alongside the eCoupon or added to www.payepos.com.

42. Payepos sample Generating E-coupon comprises:
E-Coupon is generated analyzing user usages volume, in random basis, Simulation using email, DOB, Name etc. Data from current database is transferred to data file for computer simulation and research. C/c++ Mathematics is used to analyze data in great detail to monitor user behavior and trend.

43. Payepos sample Website comprises:
Payepos users will not have to disclose their card or bank details to any website or any form of telephone sales. They can fund Payepos Card or Payepos Top Up Card by cash or Debit/Credit cards at POS checkout. After funding the card users can pay online using their Payepos Card or Payepos Top Up Card details or complete the payment at POS checkout disclosing previously obtained a shopping cart reference number or barcode at the website. This shopping cart reference number or barcode will be generated by Payepos integration mechanism with the website. User can integrate their bank, debit credit card detail at www.payepos.com for advanced and faster services.

44. Payepos sample Sharing comprises:
Epos will produce more than one up to 20 card for a family and unlimited card for business. This sharing is activated among multiple instance of one unique card or multiple unique cards sharing one account or further effective way defining additional Serial or Card number for every individual to track bearer while using same account.

45. Payepos sample Simple Sale comprises:
User can enter description data of an item in a touch screen monitor in any store. The user can define a fixed price or launch a simple auction to sell. Details will be uploaded to online. Buyer can buy item and pay using Payepos Card or Payepos Top Up Card. If a user unable or experience difficulties to upload an item anyone or customer assistant can help to upload an item.

46. Payepos sample Bank Masking comprises:
Global population is growing fast and vast number of population migrating towards cities. Electronically supplied services are core of modern life style in these cities. Digital security blocks current virus attack, but cannot stop ever growing cyber threat. Payepos Card or Payepos Top Up Card method is not a bank account and not linked to bank account but bank masking User can create and dispose cards numerous times. But for a security reason all accounts will be reconciled against name, date of birth and address. These details will reconcile all nature of single, joint or shared account.

47. Payepos sample Easy Steps comprises:
Web, mobile, monitor and touch screen interfaces are advancing in a competitive pace. Developments of features causing amateur users are left behind to coup. Even more technical users dislike new features due to lack of initial environment. In many cases new features are time consuming and not compatible with basic workflow. Main focuses of process are to present every touch screen, online interfaces and POS menu as simple as children game interfaces.
User select or click Payepos at online checkout or payment stage of a web shopping cart. Payepos allows two option pay at store or pay now on the web. If user selects pay at store, payepos generates a barcode for the shopping. Now user takes both of his Payepos Card or Payepos Top Up Card and shopping barcode to a store or shop cashier to pay for the online cart. Cashier swipe the Payepos Card or Payepos Top Up Card and select payweb among menu of Top Up, Payweb, Paytelesale, Paybill, Paysomeone etc, scan or enter shopping barcode, receive payment and complete the transactions. This process is executed in multiple possible flexible ways at POS or self service POS. If user or cashier scans the shopping barcode first POS displays message to swipe or scan the Payepos Card or Payepos Top Up Card to continue. User also can enter Payepos Card or Payepos Top Up Card details when select the pay at store option selecting an additional checkbox option. Balance is transferred from Payepos user account to web seller Payepos account.
User takes Payepos Card or Payepos Top Up Card to a store or shop. User or cashier swipe Payepos Card or Payepos Top Up Card and select Top Up among menu of Top Up, Payweb, Paytelesale, Paybill, Paysomeone etc, pay cash or use bank card to top up the card. User select or click Payepos at online checkout or payment stage of a web shopping cart. Payepos allows two option pay at store or pay now on the web. User selects pay now, Payepos allows to enter card number, security number and additional random check among those user set in advance like DOB, email etc. This process immediately completes the transaction at the website. Balance is transferred from Payepos user account to web seller Payepos account.
User takes Payepos Card or Payepos Top Up Card to a store or shop. User or cashier swipe Payepos Card or Payepos Top Up Card and select Top Up among menu of Top Up, Payweb, Paytelesale, Paybill, Paysomeone etc, pay cash or use bank card to top up the card. If user has enough balance in their Payepos Card or Payepos Top Up Card, either user or cashier can select Paysomeone and enter payee Payepos Card or Payepos Top Up Card number. Similarly user can send money to family member or friends. This process immediately completes the transaction at the store or shop. Balance is transferred from Payepos user account to web seller Payepos account. This entire process is also available at www.payepos.com, user can use online portal if comfortable to do so. User can disclose Payepos Card or Payepos Top Up Card number to other Payepos user and business to receive payments in similar way.

48. Payepos sample Shopping List comprises:
Users can create, delete shopping list in their www.payepos.com account. They share their shopping list with their assigned or authorized friend or family to shop listed items for them. Touch screen monitor or computer in store allows users to change, amend, print the list and pass message through email and text. These way users can generate shopping records using their Payepos Card or Payepos Top Up Card.

49. Payepos sample Drop Shopping comprises:
Users can shop and drop shopping in any store using Payepos Card or Payepos Top Up Card, www.payepos.com, Payepos mobile app. They share their shopping list with their assigned or authorized friend or family to shop listed items for them. Users can complete shopping, leave shopping in a safe area in the store. Touch screen monitor or computer in store allows users to email and text their authorized person. The authorized person can collect the shopping later. These way users can generate shopping records using their Payepos Card or Payepos Top Up Card.

50. Payepos sample Social Networking comprises:
Subscriber can watch friends and family using Payepos Card or Payepos Top Up Card, www.payepos.com, Payepos mobile app in their day to day life without disclosing financial details. They can message each other. Messages can be private or public like a social networking as well as all features of discussion board or others.

51. Payepos sample Rating comprises:
Local corner shop, off license, retailer can rate website for online shopping and offer option to pay using their POS, touch screen, self service POS etc. They can display website logos and address. Store and website link need to go through Payepos. Payepos and retailer can rate trustworthy websites, telesales; increase coverage and regulate terms and conditions.
Retailer or shop also can arrange simple computer and printer to enable customer for online shopping and printing the shopping barcode. User can buy and sell online item also pay for vital documents like road tax, car insurance etc.

52. Payepos sample Cash back/Cash Withdrawal comprises:
User can withdraw cash within coverage of Payment network and banking service in operating country and overseas. User can take balance to permitted country and withdraw balance there. Payepos imposes withdrawal limit and apply terms and condition regarding cash back or cash withdrawal.
